(19) United States
(12) Patent Application Publication
(10) Pub. No.: US 2011/0145040 A1
(43) Pub. Date: Jun. 16, 2011

(54) CONTENT RECOMMENDATION

(75) Inventors: Jessica E. Zahn, Renton, WA (US); Thomas C. Butcher, Seattle, WA (US)

(73) Assignee: MICROSOFT CORPORATION, Redmond, WA (US)

(21) Appl. No.: 12/639,760

(22) Filed: Dec. 16, 2009

(51) Int. Cl. G06Q 99/00; G06Q 50/00; G06Q 10/00; G06K 9/62; H04W 64/00

(52) U.S. Cl. 705/7.33; 705/347; 382/118; 455/456.3

(57) ABSTRACT

Content recommendation techniques are described. In an implementation, content preferences for a group are determined by identifying an intersection of content preferences for individual users in the group. Content that is currently available for presentation is recommended based on the intersection by comparing the content preferences for the group with metadata for the content that is available for presentation.

### BACKGROUND

Often times, a group of users may not be able to locate content that suits the users' tastes. For example, a family, who wants to watch a movie, may find it difficult to locate a movie that the family members will agree to watch. This may lead to a vocal family member effectively selecting what movie the family will watch.

In some situations, a user may have an opinion that the user does not want to share with the group for social reasons. As a result, although the user's opinion may be held by other users in the group, it may not be taken into account when selecting what content to access. Accordingly, the group may spend a significant amount of time determining what content to access which may lead to user dissatisfaction.

### SUMMARY

Content recommendation techniques are described. In an implementation, content preferences for a group are determined by identifying an intersection of content preferences for individual users in the group. Content that is currently available for presentation is recommended based on the intersection by comparing the content preferences for the group with metadata for the content that is available for presentation.

In an implementation, a determination is made of what content, that is available for presentation, is to be indicated in a recommendation for a group. The determination is made by comparing metadata for content that is available with content preferences identified from an intersection of content preferences for the individual users in the group. Sentiment information that indicates an emotion currently associated with at least one of the users in the group is used to refine what content is to be indicated in the recommendation.

In an implementation, a system includes a detector module that is configured to identify content preferences for a user associated with a mobile phone through detection of the mobile phone's presence in a local area. The content preferences are identified by monitoring content that was previously accessed when the mobile phone was in the local area. The system also includes a recommendation engine that is configured to recommend content that is available to the user by comparing the content preferences with metadata that describes the content that is currently available.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to recommend content that is available for presentation.

FIG. 2 is an illustration of a system showing an example implementation of a recommendation engine.

FIG. 3 is an illustration of a system showing an example implementation of a recommendation engine configured to recommend content to a group of users.

FIG. 4 is a flow diagram depicting a procedure in an example implementation for building a preference profile for a group of users.

FIG. 5 is a flow diagram depicting a procedure in an example implementation for recommending content for presentation to a group of users.

### DETAILED DESCRIPTION

### Overview

Users may have a wide variety of content preferences, such as genre, favorite actor, plot type, content cost, content format, content length, and so on. For example, a user may like classic westerns but dislike modern westerns. The user may also be unaware or unwilling to acknowledge some of the user's content preferences. For example, a user, who is a young male, may not wish to openly acknowledge that he dislikes violence. In other cases, the user may be unaware that he holds this negative preference. Thus, a user may find it difficult to identify content that is of interest.

A group of users may also find it difficult to decide what content to access. At times, one user in a group may dominate what content is selected for presentation. For instance, a family may watch an animated movie because a younger child is more vocal than an older child. In other situations, a group of friends may find it difficult to select a television program because one friend may not be aware of the other friends' content preferences. As a result, the group may designate one friend to decide what to watch, negotiate what content to watch, or end up switching between programs.

Content recommendation techniques are described. In an implementation, the content preferences for a group of users are determined by identifying an intersection of content preferences for the users in the group. For instance, the content preferences for the users may be mapped to identify those content preferences that are common in the group. A recommendation is provided that indicates what content is currently available for presentation and matches the content preferences of the group. In this way, the recommendation may list available content that is relevant to the group.

In the following discussion, an example environment and systems are first described that are operable to recommend content that is available for presentation. Example procedures are then described that may be implemented using the example environment as well as other environments. Accordingly, implementation of the procedures is not limited to the environment and the environment is not limited to implementation of the procedures.

Example Environment

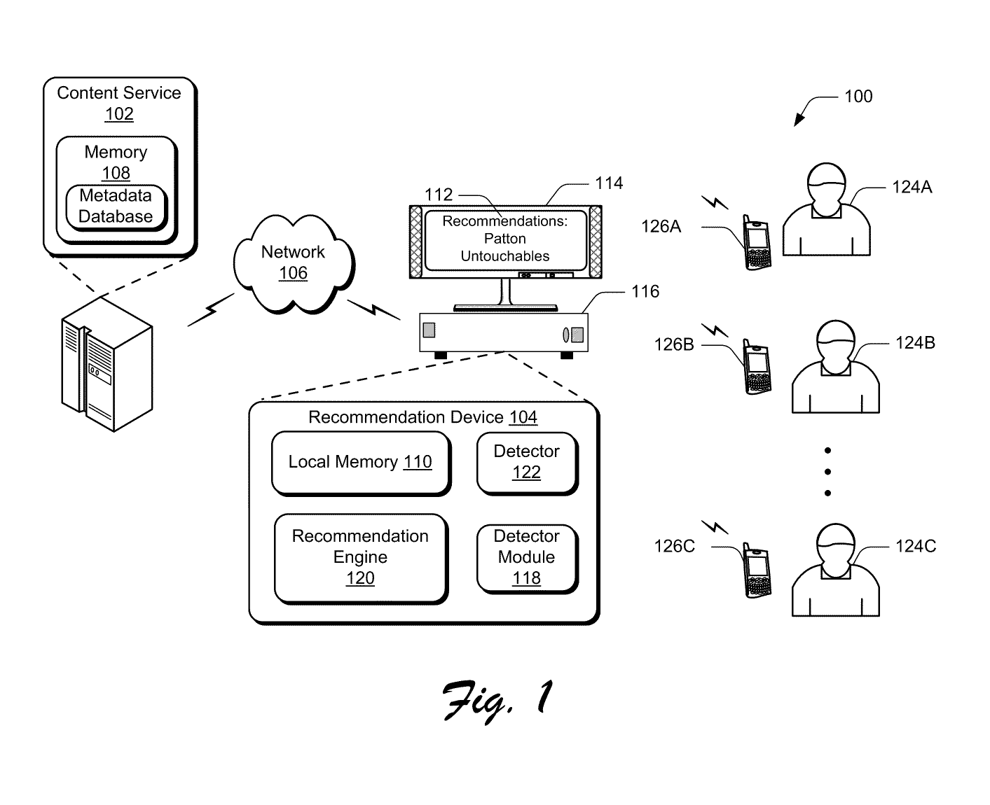

FIG. 1 is an illustration of an environment 100 in an example implementation that is operable to recommend content that is available for presentation. As illustrated, the environment 100 includes one or more content services (illustrated as content service 102) that are communicatively coupled to a recommendation device 104 via a network 106. For example, the content service 102 may be an online service that is coupled to the recommendation device 104 by the Internet.

The content service 102 may serve as a source for metadata that is used by the recommendation device 104 to make a recommendation that indicates what content is relevant to the group. For example, the content service 102 may store a database of metadata in memory 108 for content that is available for presentation. The content service 102 may also use the memory 108 to store the content or the content service 102 may access to the content from a third party, e.g., another content service.

The recommendation device 104 may use the metadata as the basis for the recommendation by identifying an intersection of content preferences for the users in the group and then comparing the content preferences that correspond to the intersection with the metadata. For example, the recommendation device 104 may identify which content preferences are prevalent in the group in order to compare them to the metadata. Thus, a western movie that is available for presentation may be recommended when a majority of users in the group prefer westerns.

The recommendation device 104 may be configured to recommend content that is currently available from a variety of sources, such as stored in local memory 110, from the content service 102, and so on. For example, the recommendation device 104 may recommend a television program that is available from a cable television provider and recommend a movie that is available for download from an Internet service. The recommendation device may also recommend content that is on after a current program, on in the next hour or later in the evening, and so forth. Content that is available may be accessed in a variety of ways. For example, the content may be downloaded from a service (e.g., an Internet service, a cable television or satellite service), available from an over-the-air service, streamed from a cable television or satellite service, and so forth.

The recommendation device 104 may provide the recommendation for output in a graphical user interface (GUI) 112 for presentation on an output device, e.g., a television 114. The GUI 112 permits a user to select which content is to be provided for output. For example, the GUI 112 may include a menu of titles from which a user may select. The GUI 112 may also provide information related to the content, information regarding the content preferences on which the recommendation is based, and so forth.

In response to user selection, the content service 102 may provide the selected content to the recommendation device 104 or to a device associated with the recommendation device, e.g., a cable television box, a satellite decoder box, a digital video recorder, and so forth.

Having described the environment 100 and an overview of the recommendation device 104, the recommendation device 104 is now described in further detail. For the purposes of illustration only, the recommendation device 104 is illustrated in FIG. 1 as included in a digital video recorder (DVR) 116. In other instances, the recommendation device 104 may be included in a variety of other devices (e.g., a video game system, a computing system, a satellite receiver/decoder box, a cable television box, and so forth), as a stand-alone device, and so on. When the recommendation device 104 is included in another device (e.g., a game system), components may be shared (although for different purposes), the functions of the recommendation device and the device in which it is included may interact and so forth. For example, the DVR 116 may record programs that are predicted to match a user's content preferences.

The recommendation device 104 illustrated in FIG. 1 includes a detector module 118 and a recommendation engine 120. Although a detector 122 and memory (e.g., local memory 110) are also illustrated, these components may be shared with the DVR 116.

The detector 122 may be used by the recommendation device 104 to detect the presence of users within a local area. Example detectors include, but are not limited to, wireless detectors, such as BLUETOOTH (Bluetooth SIG, Inc., Bellevue, Wash.) detectors, radio frequency identification (RFID) detectors, and detectors for a wireless local area network (LAN). Other detectors include video cameras, an input device (e.g., a keyboard, a mouse, and so), and so forth. For example, a digital video camera may be used to capture an image of a user's face. In another example, a BLUETOOTH detector may detect a device that implements a BLUETOOTH protocol to communicate information.

The detector 122 may monitor a local area adjacent to the recommendation device 104 to identify which users are present, e.g., users 124A-124C. The detector 122 may do this by monitoring for the user (e.g., facial recognition) or for a device (such as a media player, a personal media player, a mobile phone, a netbook, and so on) that is associated with a user. Thus, the recommendation device 104 may detect the users 124A-124C by presence of the users' mobile phones 126A-126C within the local area, e.g., in a room with the detector 122. This permits the recommendation device 104 to recommend content that is relevant to the users 124A-124C and/or associate the users 124A-124C with content being accessed.

In embodiments, a device (e.g., a mobile phone) is identified without identifying an underlying user. In this way, the recommendation device 104 may associate the mobile phone with content preferences and/or content that is accessed. By configuring the recommendation device 104 to associate content preferences with a device (e.g., mobile phone 126A), without identifying an underlying user (e.g., 124A), the recommendation device 104 may account for users who do not have an account with the recommendation device 104.

The detector module 118 is representative of functionality to identify which users are present from the detector's output. For example, the detector module 118 may perform facial recognition on the faces of people in an image to identify which users are in the local area. Upon identifying a user, the detector module 118 may obtain the user's content preferences from local memory 110 and/or from a service, such as a social networking service, the content service 102, and so on.

The recommendation engine 120 is representative of functionality to recommend content that is available for presentation by comparing the content preference for a user or a group of users with metadata for the content. For example, the recommendation engine 120 may use content preferences to recommend content to a user identified by the detector module 118.

In embodiments, the user's content preferences may be associated with one or more rules that are hierarchically related. For instance, a parent may select rules that control what content is recommended to the child and/or what content the child may or may not access.

The recommendation engine 120 may also enforce the rules on a group that includes the user. Thus, a parent may control what content is recommended to a group that includes a child and/or what content the group can access.

The recommendation engine 120 may use the content preferences and/or rules for the user develop content preferences for a group that includes the user. The recommendation engine 120 may do this by identifying an intersection of the content preferences for the users in the group in order to determine which content preferences are relevant for the group. For example, the recommendation engine 120 may determine a group's genre preference by identifying what genre the individual users prefer. Thus, the recommendation engine 120 may recommend an action-comedy for the group when a majority of the users in the group prefer action or comedy movies, e.g., by applying a “compromise approach.”

In other instances, the recommendation engine 120 may apply a “winner-take-all approach,” e.g., the group has a comedy preference because the majority of users prefer comedies. The recommendation engine 120 may determine the content preferences for the group in a variety of ways, such as by weighing some content preferences more than other content preferences, selecting some of the content preferences for use, applying a hierarchical order, and so on.

Users may also customize which content preferences the recommendation engine 120 is to use in making the determination. For instance, the users may configure the recommendation engine 120 to use some content preferences while ignoring others. Thus, a parent may configure the recommendation engine 120, based on a rule and/or content preference, to allow access to R-rated content when the parent is present, while preventing the recommendation engine 120 from recommending R-rated content when the parent is not present.

The recommendation engine 120 may also use negative preferences, e.g., a content preference that indicates a dislike. In some instances, the recommendation engine 120 treats the negative preference as a negative “vote” thereby reducing the likelihood that a particular content preference is used. In other instances, a negative preference is used to eliminate a content preference from consideration. For example, a “negative vote” by a single user may automatically eliminate that content from consideration by the group. For example, the recommendation engine 120 may not recommend a drama for a group because one of the users does not like dramas.

Once the recommendation engine 120 has the content preferences for the group it may compare the content preferences with metadata for the content that is currently available. For example, the recommendation engine 120 may check the database with the content service 102 to find content that matches the content preferences for the group.

The recommendation engine 120 may also use rules that are associated with one or more users in the group to eliminate a content preference from consideration. For example, the recommendation engine 120 may use a content preference “no adult situations” when one of the users is associated with a rule “no adult situations.” The recommendation engine may also apply a rule, that is associated with one user, but is conditioned on the presence of a different user. For instance, an older child may be allowed to watch PG movies except when a younger sibling is in the room.

In other instances, rules may be used to eliminate particular content although the content is associated with metadata that matches the group's content preferences. Thus, the recommendation engine 120 may not recommend a particular movie because it is associated with metadata that violates a rule for a user in the group.

Based on the comparison, the recommendation engine 120 recommends content that matches the group's content preferences and is currently available for presentation. The recommendation may also indicate what content preferences were used to make the recommendation, information about the content, the source of the content, a rating, cost, and so forth. The recommendation may be output in the GUI 112 that allows a user to select what content is accessed.

In embodiments, the recommendation engine 120 refines what content is recommended based on sentiment information that indicates an emotion for one or more of the users. For example, the recommendation engine 120 may recommend a comedy when the detector module 118 identifies that one of users is laughing based on a facial expression.

In embodiments, the recommendation engine 120 may use sentiment information to change the order in which content is recommended. For instance, if the user has a focused expression, the recommendation engine 120 may list dramas before comedies in the recommendation.

Generally, the functions described herein can be implemented using software, firmware, hardware (e.g., fixed logic circuitry), manual processing, or a combination of these implementations. The terms “module,” “functionality,” “service,” “engine,” “agent,” and “logic” as used herein generally represent software, firmware, hardware, or a combination of software, firmware, or hardware. In the case of a software implementation, the module, functionality, or logic represents program code that performs specified tasks when executed on a processor (e.g., CPU or CPUs). The program code may be stored in one or more computer-readable memory devices (e.g., one or more tangible media), such as random access memory (RAM), hard disk memory, and other types of computer-readable storage media and so on. The structures, functions, approaches, and techniques described herein may be implemented on a variety of commercial computing platforms having a variety of processors.

Processors are not limited by the materials from which it is formed or the processing mechanisms employed therein. For example, the processors may be comprised of semiconductor(s) and/or transistors (e.g., electronic integrated circuits (ICs)).

Moreover, the content service 102 and the recommendation device 104 may be configured to communicate with a variety of networks. Example networks include the Internet, a cellular telephone network, a local area network (LAN), a wide area network (WAN), a wireless network, a public telephone network, an intranet, and so on. Although the content service 102 and recommendation device 104 are illustrated separately, in some implementations the functions performed by recommendation device 104 may be incorporated into a service to permit over-the-cloud content recommendations. For example, the recommendation engine 120 may be included in the content service to recommend content to users of the content service. Having provided an overview of the environment 100, example implementations using systems that may use the environment 100 and/or other environments are now described.

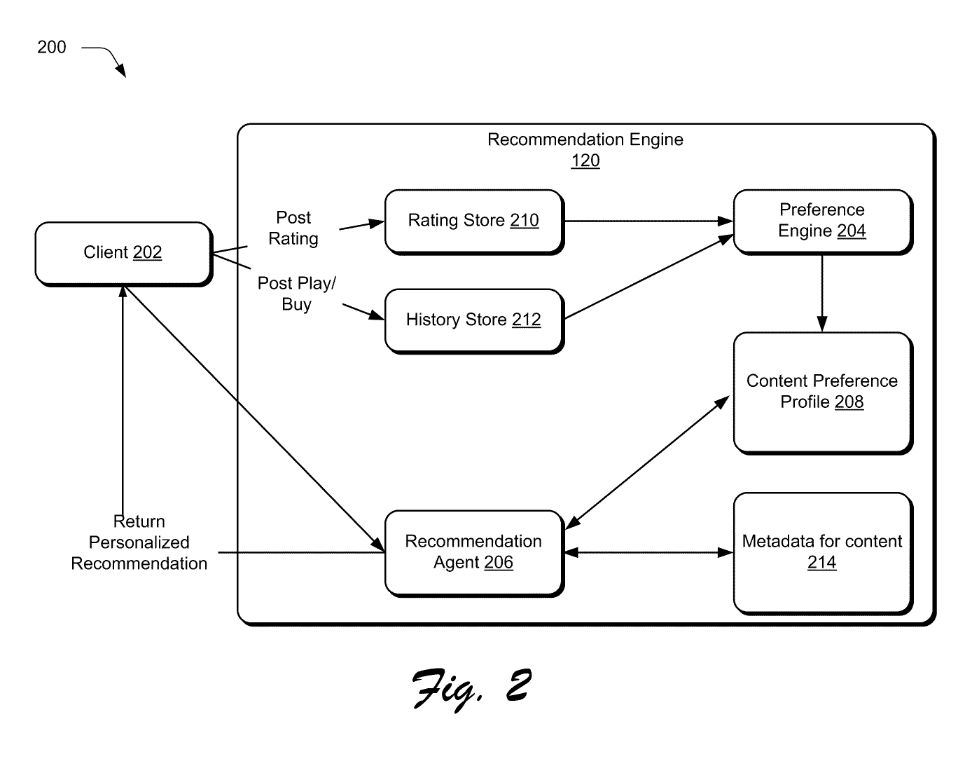

FIG. 2 depicts an example system 200 in which the recommendation engine 120 recommends content to a client 202. As illustrated, the recommendation engine 120 includes a preference engine 204 and a recommendation agent 206.

The preference engine 204 is representative of functionality to build a preference profile 208 that includes the user's content preferences. The preference engine 204 may build the preference profile 208 by monitoring what content the user's accesses, accepting user input, and so forth.

For instance, a user may express a preference for content by select a rating for a television program that is associated with the television program in the rating store 210, such as with metadata that describes the television program. Thus, if the user assigned a low rating to a western, the preference engine 204 may use this rating to exclude or reduce the likelihood that the recommendation agent 206 will recommend a western.

The preference engine 204 may also determine the user's content preferences by monitoring what content the user accesses. For example, metadata and information related to the user's content purchases and access may be entered into a history store 212 for use by the preference engine 204.

With the ratings and the information obtained from monitoring, the preference engine 204 may build a preference profile 208 that models the user's content preferences. In this way, the recommendation engine 120 may adaptively learn what content to recommend and predict what content is likely to be relevant to the user. The user's preference profile 208 may be stored in local memory 110, with the content service 102, and so on.

In response to a request for a recommendation, the recommendation agent 206 may compare the content preferences to metadata 214 for content that is currently available from one or more of the content service 102, local memory 110, and so forth. The recommendation agent 206 may then provide the client 202 with a recommendation that indicates what content matches the users' content preferences. For example, the recommendation agent 206 may provide a list of content that is associated with metadata that matches the user's content preferences. Having described how the recommendation engine 120 may build a preference profile 208 and recommend content to the user, building a preference profile for a group and recommending content to a group is discussed below.

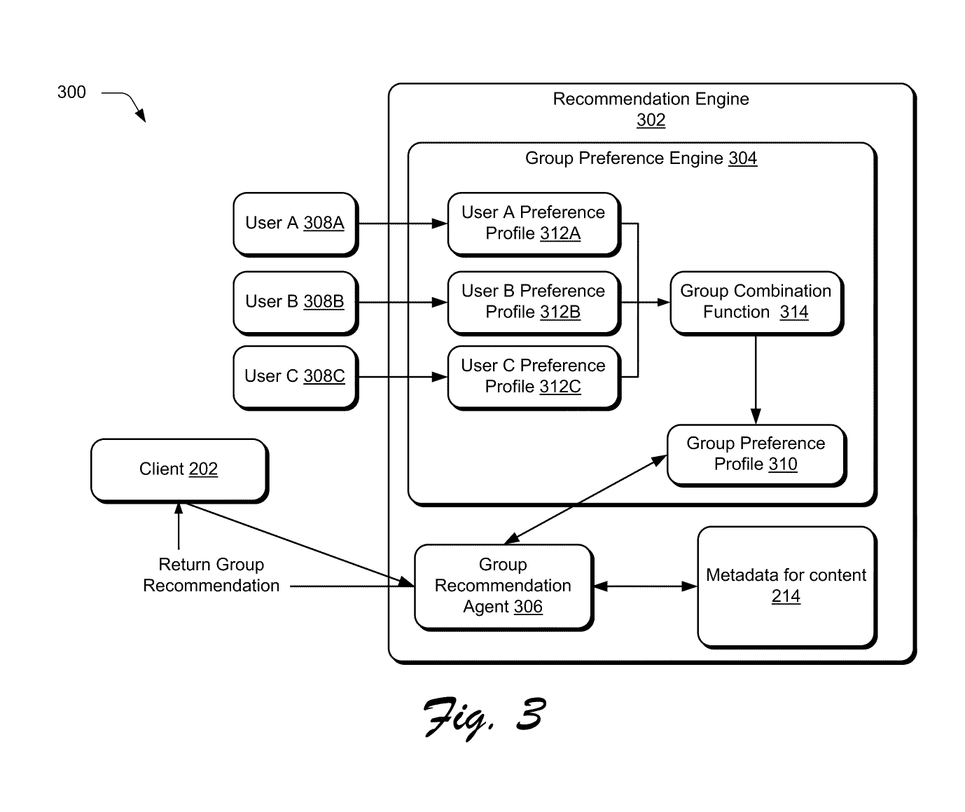

FIG. 3 illustrates a system 300 having a recommendation engine 302 that includes a group preference engine 304 and a group recommendation agent 306. Although the recommendation engine 302 is described in conjunction with recommending content for a group, the capabilities, functions, and so forth described in conjunction with the recommendation engine 120 may be incorporated into the recommendation engine 302.

In embodiments, the group preference engine 304 may aggregate the content preferences for individual users (e.g., A, B, and C, 308A-308C) to determine the content preferences for a group. For example, the group preference engine 304 may build a group preference profile 310 by aggregating the users' content preferences from the user's preference profiles, e.g., user A preference profile 312A, user B preference profile 312B, and user C preference profile 312C. In this way, the group preference engine 304 may identify the intersection of content preferences for the group, including users A, B, and C 308A-308C, by using a group combination function 314 to aggregate the content preferences included in the users' preference profiles. Thus, the content preferences for the group may reflect the content preferences of the users in the group.

In other embodiments, the group preference engine 304 aggregates the preferences profiles for the individual users. For example, the group preference engine 304 may implement a group combination function 314 on the preference profiles for the individual users (A preference profile 312A, user B preference profile 312B, and user C preference profile 312C) to build the group preference profile 310. With the group preference profile 316 in place, the group recommendation agent 306 may compare the content preferences in the group preference profile 310 with metadata 214 for content that is available from one or more of local memory 110, the content service 102, and so on to recommend content for presentation as described above.

Example Procedures

The following discussion describes procedures that may be implemented utilizing the previously described systems, techniques, approaches, services, and modules. Aspects of each of the procedures may be implemented in hardware, firmware, software, or a combination thereof. The procedures are shown as a set of blocks that specify operations performed by one or more devices (e.g., computing systems) and are not necessarily limited to the orders shown for performing the operations by the respective blocks. In portions of the following discussion, reference will be made to the environment 100 of FIG. 1 and the systems of FIGS. 2 and 3.

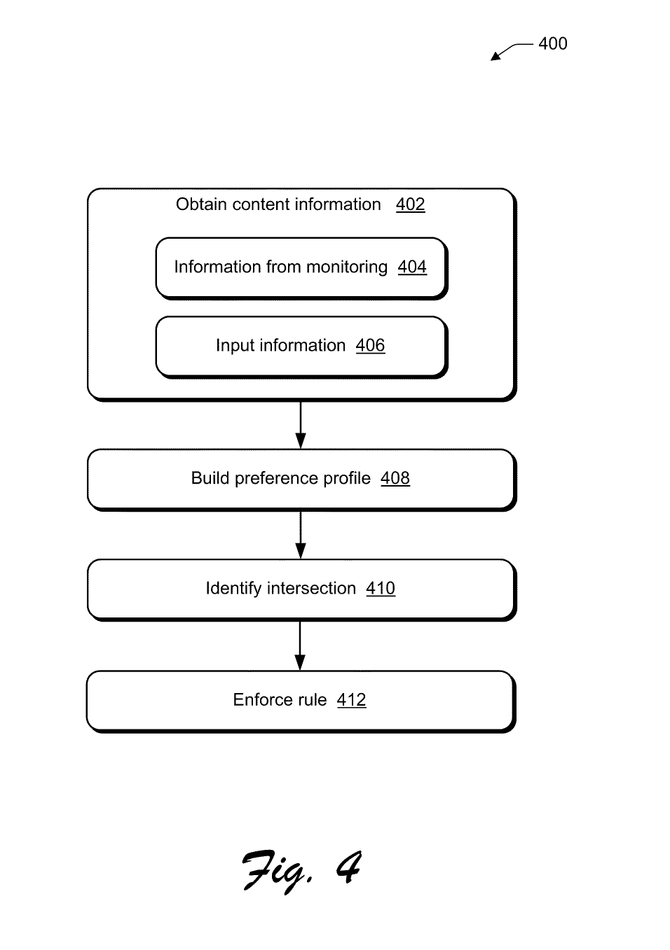

FIG. 4 depicts a procedure 400 for building a group preference profile. Although the procedure 400 is described with respect to a group, the techniques, approaches may be used to build preference profiles for individual users which may be used as the basis for building a group profile.

A user's content preferences are obtained from information that indicates what content the user prefers (block 402). The information may obtained by monitoring what content the user accesses (block 404). The information may also be expressed by or on behalf of the user (block 406). For example, a device implementing the procedure 400 may collect metadata for a movie that the user accessed and/or accept an input that indicates a ranking for the movie. A user may input the ranking using a keyboard included on a device performing the procedure and/or through use of a device associated with the user, e.g., the user's mobile phone.

The content preferences are used to build a preference profile (block 408). For example, the preference profile may model the user's content preferences so the recommendation device 104 may predict what content is likely to be of interest to the user. In this way, the content preferences may be used as points of comparison with metadata to find content that is of interest to the user.

An intersection of content preferences for the users in a group is identified (block 410). For example, the intersection may be identified by aggregating the content preferences of the users in the group. In another example, the preference profiles for the users in the group are aggregated using a group combination function to obtain a group preference profile that contains the content preferences for the group.

In embodiments, a rule associated with one or more of the user in the group is enforced (block 412). For example, if one of the users is associated with a rule “no violence,” the content preference for the group may include a no violence rule. The rule “no violence” may be enforced even though the content preferences for the other users in the group permit violence.

It is to be apparent that the preference profile for the group may be created at different points-in-time from one or more preference profiles for the users. Thus, a device performing the procedure may build and store a preference profile for a user and then implement the preference profile for the user as the basis for building a group preference profile at a later time. Although the procedure 400 is discussed in reference to a recommendation device, a service may be used in conjunction with the procedure 400. Having discussed building user profiles and group preference profiles, use of these profiles is discussed below.

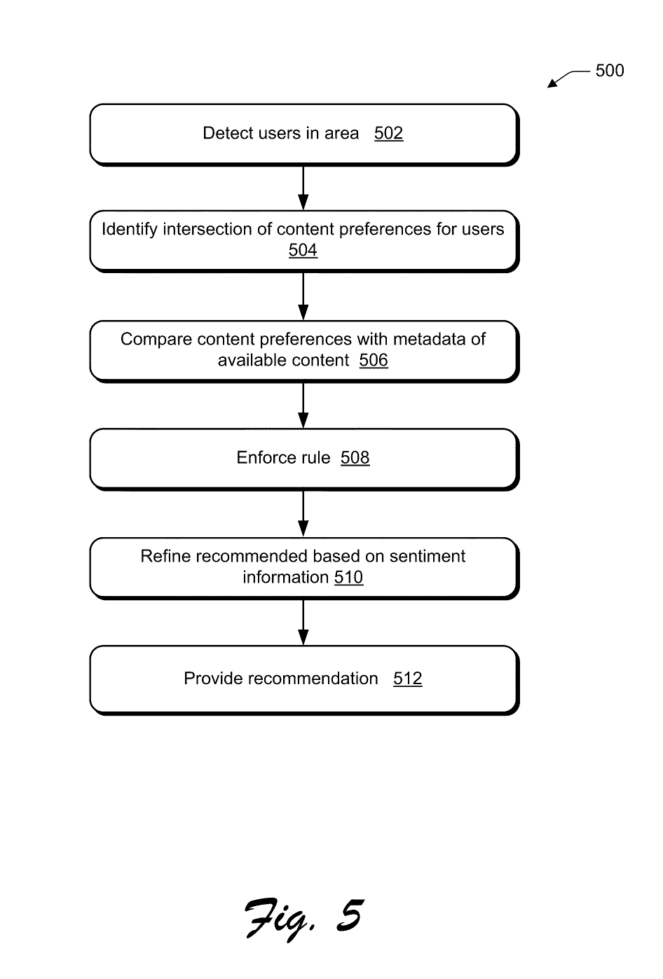

FIG. 5 depicts a procedure 500 for recommending content to a group of users. The procedure 500 may be performed in response to a request for a recommendation or automatically, such as upon the occurrence of an event. For example, the procedure 500 may be triggered automatically at the end of a movie, e.g., “if you like this movie, you may also like . . . ”

Users who are present in a local area are detected (502). The presence of users in the local area may be established by detecting the presence of the user directly, e.g., facial identification, manual user input and so on. In some instances, the user's presence and identity may be detected by detecting a device associated with the user in the local area. For example, a user may be identified by a RFID key-fob that is usable to conclude finical transactions. The local area may be associated with a physical feature (e.g., in the same room), in a specified area, e.g., within the detector's range, and so on. Although a user's presence and identity may be established by the presence of a device, in other instances the device's identity and presence may be established without associating the device to a user.

An intersection of content preferences is identified for the users who are present within the area (block 504). The intersection of content preferences may be established by aggregating the content preferences for the users or by aggregating the preference profiles for the users to build a group preference profile.

The content preferences for the group are compared to metadata for content that is currently available for presentation (block 506). For example, a device performing the method 500 may compare the content preference for the group with a database of metadata for content that is available from one or more of the content service, local memory, and so forth.

In embodiments, a rule associated with one or more of the users in the group is enforced on the content that is to be recommended (block 508). For example, if metadata for an audio clip is prohibited by the rule, the audio clip is not recommended to the group even though the audio clip corresponds to the content preferences for the group.

In embodiments, content that is to be recommended is refined based on sentiment information (block 510). Sentiment information may indicate an emotion for one or more users in the group. Thus, if users are in a serious mood, dramas may be recommended while comedies are not recommended. A device refining what content is presented based on sentiment information may compare the sentiment information to the metadata for the content in order to determine what content matches the users' current mood.

A recommendation is provided (block 512). The recommendation may indicate what content that is currently available for presentation, provide additional information about the content, indicate what content preferences were used, allow for user override, and so forth. For example, the recommendation may be provided for output in a GUI that is configured to accept user selection. Although a device is discussed, in instances a service that is available over a network, such as the Internet, may be used conjunction with the procedure 500.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
determining content preferences for a group of users by identifying an intersection of content preferences for individual users in the group; and
recommending content that is currently available for presentation based on the intersection by comparing the content preferences for the group with metadata for the content that is available for presentation.

2. A computer-implemented method as described in claim 1, wherein the recommending content is based on one or more rules that are hierarchically related and associated with at least one of the users in the group.

3. A computer-implemented method as described in claim 1, wherein the determining the content preferences for the group is performed responsive to a request for a recommendation.

4. A computer-implemented method as described in claim 1, wherein the intersection corresponds to content preferences that are common among a majority of the users in the group.

5. A computer-implemented method as described in claim 1, wherein the content preferences for a user in the group are based on one or more of an expressed preference or metadata associated with content previously accessed by at least one of the users in the group.

6. A computer-implemented method as described in claim 1, wherein a negative preference associated with a user in the group is automatically included in the content preferences for the group.

7. A computer-implemented method as described in claim 1, wherein at least one of the content preferences for the group matches a content preference for a user in the group.

8. A computer-implemented method comprising:
determining what content, that is available for presentation, is to be indicated in a recommendation for a group, wherein the content in the recommendation is determined by comparing metadata for the content with content preferences identified from an intersection of content preferences for individual users in the group; and
refining what content is to be indicated in the recommendation according to sentiment information that indicates an emotion currently associated with at least one of the users in the group.

9. A computer-implemented method as described in claim 8, wherein the determining further comprises eliminating content from being indicated in the recommendation that is prohibited by one or more rules that are hierarchically related and associated with one of the users in the group.

10. A computer-implemented method as described in claim 8, wherein the sentiment information is obtained by performing facial recognition on the at least user.

11. A computer-implemented method as described in claim 10, further comprising identifying the individual users in the group using facial recognition.

12. A computer-implemented method as described in claim 8, wherein the computer-implemented method is performed by a video game system.

13. A computer-implemented method as described in claim 8, wherein the determining further comprises accessing multiple content services to locate the content that is available for presentation.

14. A computer-implemented method as described in claim 8, wherein the sentiment information is detected based on a manual input.

15. A system comprising:
a detector module configured to identify content preferences for a user associated with a mobile phone through detection of the mobile phone's presence in a local area, wherein the content preferences are identified by monitoring content that was previously accessed when the mobile phone was in the local area; and
a recommendation engine configured to recommend content that is available to the user by comparing the content preferences with metadata that describes the content that is currently available.

16. The system as described in claim 15, wherein the recommendation engine is further configured to aggregate content preferences for multiple users, that are associated with mobile phones detected in the local area, to determine content preferences for a group.

17. The system as described in claim 16, wherein at least one of the content preferences for the group matches a content preference for the user.

18. The system as described in claim 15, wherein the system is configured to accept a ranking input via the mobile phone.

19. The system as described in claim 15, wherein the system comprises a video game system.

20. The system as described in claim 15, wherein the mobile phone's presence is determined though use of a BLUETOOTH protocol.
